(19) United States
(12) Patent Application Publication
(10) Pub. No.: US 2024/0415096 A1
(43) Pub. Date: Dec. 19, 2024

(54) ANIMAL WELFARE ECOSYSTEM AND METHOD OF USING THE SAME

(71) Applicant: Habit Technology, LLC, Cincinnati, OH (US)

(72) Inventors: Kathryn L. Kalafut, Cincinnati, OH (US); David M. Freestone, Cheverly, MD (US); Matthew D. Regele, Hamilton, OH (US); Dieter Vanderelst, Cincinnati, OH (US)

(21) Appl. No.: 18/745,507

(22) Filed: Jun. 17, 2024

Related U.S. Application Data
(60) Provisional application No. 63/521,427, filed on Jun. 16, 2023.

(51) Int. Cl. A01K 11/00; A01K 1/01; A01K 5/02; A01K 7/06; A01K 15/02; A01K 29/00

(52) U.S. Cl. CPC A01K 11/006; A01K 29/005; A01K 1/0107; A01K 5/025; A01K 7/06; A01K 15/025

(57) ABSTRACT

An animal welfare ecosystem comprising: a plurality of animal interactive devices, wherein each animal interactive device of the plurality of animal interactive devices is capable of measuring an animal's interaction with said animal interactive device; and a computational hub in a communicative connection with each animal interactive device of the plurality of animal interactive devices. Animal interaction at one animal interactive device will activate one or more of the other animal interactive devices to perform an activity.

### CROSS REFERENCE TO RELATED APPLICATION

The present application claims the priority benefit of U.S. Provisional Application No. 63/521,427, filed Jun. 16, 2023, the disclosure of which is hereby incorporated by reference in its entirety.

### TECHNICAL FIELD

The present disclosure relates to an animal welfare ecosystem. The animal welfare ecosystem of the present disclosure integrates behavior monitoring and incentivizing technologies to offer opportunities to allow the animal(s) to engage in healthier behaviors.

### BACKGROUND

Like people, animals often do not engage in the healthiest of behaviors. Like us, they may cat too much, may not drink enough water, and may not be active enough. A growing number of companies use technology to try to monitor certain behaviors and encourage healthier ones. The problem is that these innovations can monitor behavior and hope that healthier behaviors emerge, but do not directly change behavior.

To some extent, this is a problem for humans, health monitors tell us we aren't taking enough steps, and they may communicate new goals or step objectives. With humans, we are aware of the problem and understand what we “should” be doing. The problem is much more challenging when it comes to animals. Although similar devices have been developed for them, animals do not change behavior on their own. For example, a “smart” water bowl might indicate that more water intake would be beneficial, but they do very little to actually encourage the animal to drink more. Another issue is that most humans are not equipped to intervene and change the behavior of animals in their care. Just like horses, you can lead a cat to water, but you can't make him drink.

Generating healthier behaviors in animals requires not only monitoring what they are currently doing, but actively incentivizing and offering opportunities to engage in better (i.e., healthier) behaviors. Therefore, there is a need in the art for a system which integrates behavior monitoring technology with science-backed, automated incentive provisions to actually change animal behavior for better health and wellness.

### BRIEF DESCRIPTION OF THE DRAWINGS

Various versions will become better understood with regard to the following description, appended claims and accompanying drawings wherein:

FIG. 1 is a block diagram illustrating a version of the animal welfare ecosystem of the present disclosure; and

FIG. 2 is a block diagram illustrating yet another version of the animal welfare ecosystem of the present disclosure.

### DETAILED DESCRIPTION

Various non-limiting versions of the present disclosure will now be described to provide an overall understanding of the principles of the structure, function, and use of the apparatuses, systems, methods, and processes disclosed herein. One or more examples of these non-limiting versions are illustrated in the accompanying drawings, wherein like numbers indicate the same or corresponding elements throughout the views. Those of ordinary skill in the art will understand that systems and methods specifically described herein and illustrated in the accompanying drawings are non-limiting versions. The features illustrated or described in connection with one non-limiting version may be combined with the features of other non-limiting versions. Such modifications and variations are intended to be included within the scope of the present disclosure.

Reference throughout the specification to “various versions,” “some versions,” “one version,” “some example versions,” “one example version,” or “a version” means that a particular feature, structure, or characteristic described in connection with any version is included in at least one version. Thus, appearances of the phrases “in various versions,” “in some versions,” “in one version,” “some example versions,” “one example version,” or “in a version” in places throughout the specification are not necessarily all referring to the same versions. Furthermore, the particular features, structures or characteristics may be combined in any suitable manner in one or more versions.

The examples discussed herein are examples only and are provided to assist in the explanation of the apparatuses, devices, systems, and methods described herein. None of the features or components shown in the drawings or discussed below should be taken as mandatory for any specific implementation of any of these apparatuses, devices, systems, or methods unless specifically designated as mandatory. For case of reading and clarity, certain components, modules, or methods may be described solely in connection with a specific figure. Any failure to specifically describe a combination or sub-combination of components should not be understood as an indication that any combination or sub-combination is not possible. Also, for any methods described, it should be understood that unless otherwise specified or required by context, any explicit or implicit ordering of steps performed in the execution of a method does not imply that those steps must be performed in the order presented but instead may be performed in a different order or in parallel.

The present disclosure integrates behavior monitoring technology with science-backed, automated incentive provisions to actually change animal behavior for better health and wellness. The present disclosure achieves these benefits by connecting devices that collect, analyze, store, use, and share behavioral data, while adjusting incentives accordingly. Depending on the species and specific problematic behaviors, interventions may be used on an ongoing basis or to train the animal to engage in healthier behavior on their own over time. In situations where multiple animals are housed in the same area, the present disclosure may also be able to automatically identify individual animals and tailor interventions to each. In one or more versions, as few as two devices can be connected to one another or they can be connected through a communication hub to prevent or treat individual problems. For example, inadequate water consumption in cats (a very common problem that contributes to kidney disease) can be addressed by integrating a water dispenser that monitors water consumption with an feeder that dispenses food as an incentive. Alternatively, several different devices might be integrated to improve several behaviors and address multiple health issues. In one or more versions, an entire ecosystem of devices can be connected to promote healthy lifestyles through better nutrition, exercise, and mental stimulation.

Although the versions discussed below may only discuss their use with a domesticated cat, the present disclosure may not be so limited. In one or more versions, the system of the present disclosure can be utilized with any domesticated animal, including those housed in shelters; livestock and other agricultural or aquaculture animals; animals housed in zoos, aquariums, and similar facilities; animals being used in research; efforts to protect wild animals such as, for example, fish in rivers or around offshore wind turbines; and any other animals that need training.

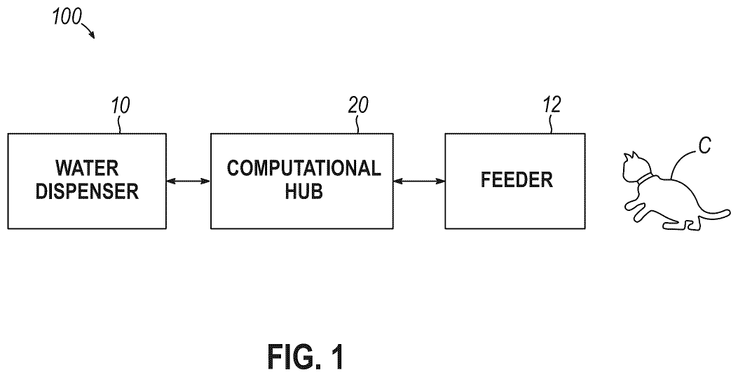

In the version shown in FIG. 1, ecosystem 100 includes two animal interactive devices, including a water dispenser 10 connected to a feeder 12. In its simplest form, once a cat C drinks from water dispenser 10, water dispenser 10 sends drinking data to a computational hub 20, which can then pass along said drinking data to feeder 12. If computational hub 20 determines that an appropriate amount of water has been consumed from water dispenser 10, computational hub 20 can instruct feeder 12 to release food. The cat can then learn to associate drinking water with an incentive, in this case food, and over time through using the principles of positive reinforcement, the cat can adjust its behavior. Although FIG. 1 shows water dispenser 10 and feeder 12 as two separate devices, versions of the present invention envision that both water dispensing element and feeding element are combined into one compact device.

Although the version shown in FIG. 1 contemplates computational hub 20 as a stand-alone device, it is also contemplated that the concept of computational hub 20 can be envisioned as software that has been uploaded into all of the elements of ecosystem 100, such as water dispenser 10 and feeder 12, without the need for a separate stand-alone computational hub 220. In yet other versions, one of the elements of ecosystem 200, such as water dispenser 10 and feeder 12 can have additional hardware built into the device that acts as computational hub 20, without the need for a separate stand-alone computational hub 20.

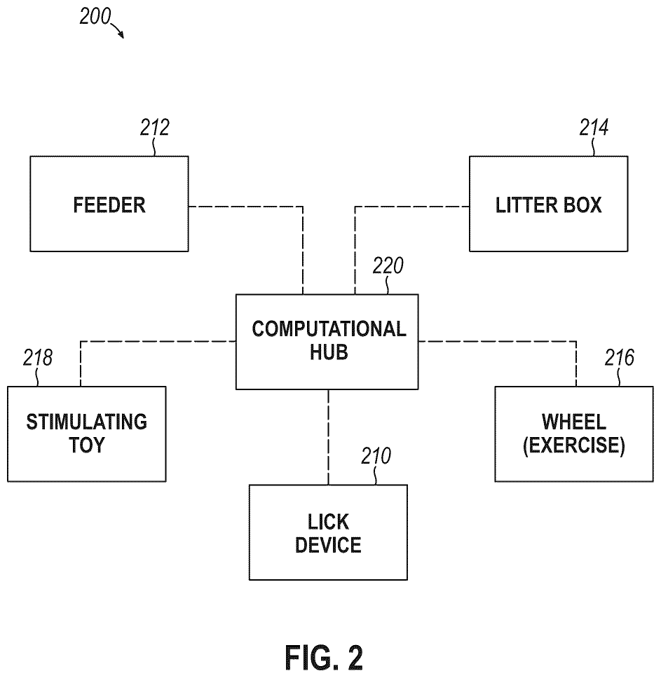

In the versions shown in FIG. 2, ecosystem 200 includes a plurality of animal interactive devices, including water dispenser 210, a feeder 212, a litterbox 214, an exercise device 216, a stimulating toy 218, and a computational hub 220. In this version, once a cat drinks from dispenser 210, dispenser 210 sends drinking data to computational hub 220. Computational hub 220 then sends the drinking data to one or more of feeder 212 or stimulating toy 218. Similar to the version shown in FIG. 1, if an appropriate amount of water has been consumed from dispenser 210, then feeder 212 may release food. Additionally, if an appropriate amount of water has been consumed from dispenser 210, stimulating toy 218 may perform an activity which stimulates the cat. In one version, stimulating toy 218 could be a feather attached to a device which moves the feather, or stimulating toy 218 could be a device that throws a ball for the cat to chase.

Although the version shown in FIG. 2 contemplates computational hub 220 as a stand-alone device, it is also contemplated that the concept of computational hub 220 can be envisioned as software that has been uploaded into all of the elements of ecosystem 200, such as water dispenser 210, feeder 212, litterbox 214, exercise device 216, and stimulating toy 218, without the need for a separate stand-alone computational hub 220. In yet other versions, one of the elements of ecosystem 200, such as water dispenser 210, feeder 212, litterbox 214, exercise device 216, and stimulating toy 218 can have additional hardware built into the device that acts as computational hub 220, without the need for a separate stand-alone computational hub 220.

In one or more versions, computational hub 20/220 is in the form of software, wherein the software may interface with other devices and their software/hardware systems. In one or more versions, the software of computational hub 20/220 may be in multiple formats such that one aspect of the software does more computationally heavy processes that it then passes off to another aspect of the software that works to create the output.

Furthermore, versions of the present disclosure also contemplate a dashboard or mobile application that receives data from the computational hub 20/220, which receives data from each device within system 100/200. This dashboard or mobile application can be used by owners or caretakers of animals utilizing system 100/200 to track the behavior and health of the animals over time utilizing the information gleaned from the collected data. The dashboard or mobile application will be operably connected to computational hub 20/220, or individually to each device if computational hub 20/220 is not present. Therefore, owners and caretakers can additionally send activity instructions through the dashboard or mobile application to each device for purposes such as their initial setup or to change settings on each device as they see fit.

In one or more versions, litterbox 214 may be enabled to track when the cat urinates and/or defecates, and that data may be collected as elimination data. Litterbox 214 could then send elimination data to computational hub 220. Computational hub 220 then sends the elimination data to one or more of feeder 212 or stimulating toy 218. If elimination data reveals that the cat has had a healthy elimination event, then feeder 212 may release food. Additionally, if elimination data reveals that the cat has had a healthy elimination event, then stimulating toy 218 can perform an activity which stimulates the cat. In one version, stimulating toy 218 could be a feather attached to a device which moves the feather, or stimulating toy 218 could be a device that throws a ball for the cat to chase, or retrieve.

In one or more versions, exercise device 216 may be selected from the group consisting of an exercise wheel, treadmill, agility seesaw, or other similar devices. In the version shown in FIG. 2, exercise device 216 is in the form of an exercise wheel and may be enabled to track when the cat has utilized exercise device 216, and that data may be collected as exercise data. Exercise device 16 could then send exercise date to computational hub 220. Computational hub 220 then sends exercise data to one or more of feeder 212 or stimulating toy 218. If exercise data reveals that the cat has performed enough exercise on exercise device 216, then feeder 212 can release food. Additionally, if exercise data reveals that the cat has performed enough exercise on exercise device 216, then stimulating toy 218 can perform an activity which stimulates the cat. In one version, stimulating toy 218 could be a feather attached to a device which moves the feather, or stimulating toy 218 could be a device that throws a ball for the cat to chase or retrieve.

A goal of the systems 100/200 of the present disclosure can be to not only measure various aspects of an animal's well-being, but to use this information to alter an animal's environment to maximize their physical and behavioral well-being. Physical and behavioral health are linked. For example, an animal's weight (an aspect of physical health) can be altered through more or less activity (an aspect of behavioral health). As a result, physical and behavioral health need to be addressed in tandem. This may require measuring and evaluating both aspects to determine the best course of action to ensure the highest degree of welfare. Each device within the systems 100/200 of the present disclosure has both intra-device and inter-device communication. The data collected may not only be used to monitor behavioral and physical health but may be integrated and analyzed to make informed decisions about what actions the ecosystems 100/200 should implement to increase, decrease, or maintain specific behaviors and enhance overall welfare. Each device, such as water dispenser 10/210, feeder 12/212, litterbox 214, exercise device 216, and stimulating toy 218 can be used in combination with one or more other devices in ecosystems 100/200 to create various levels of support. What follows can be a general design and components of the devices discussed above, as well as additional information as to how each device may function within the systems 100/200 of the present disclosure.

In one or more versions, if multiple animals are being trained within system 100/200 of the present disclosure, each device can all include a device, such as an RFID reader or a camera, which can assist in identifying the specific animal performing activities on a device. In one or more versions, if the system utilizes an RFID reader, each animal could wear an RFID tag that is readable by the RFID reader to identify the specific animal. In one or more versions, the devices of systems 100/200 can also be adapted for different species of animals being trained within systems 100/200, who may engage with the system in different ways. For example, the devices can be adapted to be activated by a dog's paw and the nose of a cow.

In one or more versions, water dispenser 10/210 includes a water receptacle such as a bottle or dish and a plate that sits in front of a water receptacle. In practice, the cat may have to stand on this plate to drink from the water receptacle. Water dispenser 10/210 additionally includes an element to measure the amount of water leaving the water receptacle. In one or more versions, the element to measure the amount of water includes a scale which measures the weight of the water receptacle, a positive flow meter which measures water flow, an infrared sensor, a sonar sensor, a pressure sensor, or combinations thereof. In one or more versions, water dispenser 10/210 further includes a lick-circuit board. The lick circuit board detects licks of the water receptacle by sending a small electrical current through both the water receptacle and the plate the cat can be standing on to drink from the water receptacle. With the current ‘closed’ (which may mean that the animal is standing on the plate and is licking the water receptacle), the circuit detects this connection and records a lick.

The lick-circuit board measures licks to the water receptacle and corresponding changes to the amount of water in the water receptacle. It would work on its own to provide information on drinking behavior, but paired with other devices, reinforces water drinking with other activities or stimuli, such as food or play. In one or more versions, the lick-circuit board includes software to detect when licks are happening and to continuously measure the water leaving the receptacle. When both of these measures meet a certain threshold, other environmental events may occur at other devices as discussed above (e.g., food may be delivered, or a toy may be deployed). As the animal learns that drinking produces food, drinking behavior increases. Water dispenser 10/210 may be programmable to alter the amount of drinking activity that may be needed to produce food gradually over time. For example, if two licks of water dispenser 10/210 on day 1 within the systems 100/200 of the present disclosure allows for feeder 12/212 to release food, on day 2 water dispenser 10/210 can be updated to perhaps necessitate three licks prior to feeder 12/212 releasing food.

Increases automatically continue until the ideal amount of water consumption for that individual animal can be reached. This can be measured not only based on changes in water in water dispenser 10/210, but also based on the animal's urination. More specifically, lick device of water dispenser 10/210 may be connected to a defecation device, such as litterbox 214, and the animal may be urinating more or less frequently, spending more or less time in the litterbox, excreting too much urine or urine with a specific pH, amounts of glucose, protein, and/or white or red blood cells. Water dispenser 10/210 can be programmable such that protocols may be changed to ensure the appropriate levels of drinking. The threshold can be determined by past behavior, current behavior, and characteristics of the individual animal (e.g., weight, age, species, etc.). Conversely, if the animal is not drinking enough, water dispenser 10/210 may be programmable to be able to automatically increase the amount of food deployed and/or decrease the number of licks that may be needed to produce a given outcome.

In one or more versions, water dispenser 10/210 also includes time sensors to determine when the water consumption took place. This data point may then be added to the data set associated with water dispenser 10/210.

In one or more versions, feeder 12/212 includes a storage vessel that houses the food to be delivered and a mechanism to deliver the food. In one or more versions, the mechanism to deliver the food can be a wheel that spins to allow food to pass. The longer the wheel spins, the more food may be delivered. In one or more versions, the mechanism to deliver the food includes a wheel within rotating bins secured there to which carries the food. This mechanism works similarly to a wheel slide case for a projector. The food may be in individual slots and as the wheel turns the food in the slots drops. The more the wheel rotates, the more slots of food drop.

In one or more versions, feeder 12/212 also includes a circuit board that controls the mechanism to deliver food and communication components to send information (i.e., feeder deployed) and receive information (i.e., deploy the feeder) to other devices within system 100/200 or directly to computational hub 20/220.

In one or more versions, feeder 12/212 may be programmable to allow for food to be delivered at a specific time, even without the needed activity on another device within system 100/200. However, as discussed above, feeder 12/212 may also be programmable to be integrated with other devices within system 100/200 to reinforce certain behaviors. All animals need to cat, and food typically serves as a valued reinforcement mechanism for certain behaviors. When a desired behavior occurs (certain amount of activity, drinking behavior, play, etc.), as discussed above, feeder 12/212 can be activated. In one or more versions, feeder 12/212 may be programmable to contain limits on the total amount of food to be delivered in a certain period or a maximum number of times that feeder 12/212 can deliver food to ensure that the animals are getting appropriate amounts of food.

In one or more versions, feeder 12/212 receives information of when to deploy food, while also sending information that food has actually been deployed. Feeder 12/212 can alter the amount of food delivered (based on the physiological needs of the animal), when to deliver the food, or stop delivering food (if the animal has earned enough for their daily allotment).

In one or more versions, feeder 12/212 also includes time sensors to determine when the food was delivered and when the food was ultimately consumed. These data points are then added to the data set associated with feeder 12/212.

In one or more versions, litterbox 214 includes a defined area that collects animal excrement. In one or more versions, litterbox 214 may be capable of recognizing the presence of an animal in the defined area, as well as being able to identify the type and amount of excrement produced by the animal within the defined area. In one or more versions, the excrement data collected includes pH, amount, consistency, length of time spent in the defined area, and combinations thereof. Litterbox 214 may be capable of sending the excrement data collected to the computational hub 220 or to another device of system 200 for monitoring and analysis. In one or more versions, litterbox 214 also includes time sensors to determine when the excrement events took place. These data points are then added to the data set associated with litterbox 214.

In one or more versions, exercise device 216 includes a wheel that the animal can use to run or walk in place. In one or more versions, the wheel may be scalable to the size of the animal to be trained within system 200 of the present disclosure. Exercise device 216 further includes a sensor that detects and computes revolutions and the directionality on a wheel and a brake that slows down or stops the wheel.

Exercise device 216 allows the animal to engage in healthy activity (i.e., walking or running). Exercise device 216 also measures and incentivizes this activity. Exercise device 216 can be used in concert with feeder 212 such that if an animal is not engaging in enough activity, feeder 212 may be used to incentivize more appropriate activity levels in a similar manner to increasing drinking behavior as discussed above. At first, a single revolution might produce food or another desired outcome; however, exercise device 216 may be programmable such that it may need more revolutions before releasing food from feeder 212. Exercise device 216 may also be programmable such that it can also make using the wheel more interactive, for example by increasing resistance or requiring changes in directionality to ensure mental stimulation. In one or more versions, exercise device 216 may be capable of measuring revolutions of the wheel, speed of the wheel, and directionality of movement of the wheel. Exercise device 216, specifically the brake of exercise device 216, can also stop or slow the wheel based on the animal's activity. Exercise device 216 also sends and receives information on all of these measures and changes.

In one or more versions, exercise device 216 also includes time sensors to determine when the exercise took place. This data point may then be added to the data set associated with exercise device 216.

In one or more versions, stimulating toy 218 includes an item or items that can be manipulated by an animal in a species typical manner, and a measurement device capable of measuring manipulation of the item or items. In one version, the item may be a ball and retrieval system. In one or more versions, the measurement device may be an accelerometer, Omni-directional lever, tension lever, or combinations thereof. Stimulating toy 218 can be utilized to increase healthy activities that allow the animal to get some form of exercise.

In one or more versions, stimulating toy 218 may be capable of collecting information about usage and sending that information to computational hub 220 or to another device of system 200 for responses. In one version, a certain amount of play with stimulating toy 218 allows for feeder 212 to release food. Stimulating toy 218 may also be programmable to interact with the animal based on the passage of a select amount of time. For example, if 2 hours have passed without the animal interacting with stimulating toy 218, then a ball can be thrown. Stimulating toy 218 may also be capable of receiving information sent by other devices. For example, if the animal drinks a certain amount of water at water dispenser 210, then stimulating toy 218 throws the ball. Stimulating toy 218 may also be programmable, based on the exercise data collected, to cater specific movements/play styles to an animal's preference. For example, a certain frequency of shaking of a feather may cause the animal to play more than others or a certain time interval of a ball being deployed may extend play time. In one or more versions, stimulating toy 218 also includes time sensors to determine when the animal played with stimulating toy 218. This data point may then be added to the data set associated with stimulating toy 218.

Although not specifically shown in the drawings, systems 100/200 also contemplates the use of a scale as a device within systems 100/200. The scale can send information about the animal's weight. In one or more versions, the scale may be capable of receiving information about when to tare the scale or when to turn off the scale. In one or more versions, if an animal sits on the scale for a certain amount of time such that an accurate weight measurement can be determined, feeder 12/212 may release food or play may be initiated at stimulating toy 218.

Although not specifically shown in the drawings, systems 100/200 also contemplates that every animal being trained by systems 100/200 wears an activity tracker which records and tracks the activity level of the animal when the animal is not interacting with any of the abovementioned devices. In one or more versions, the activity tracker processes the activity data collected and provides the activity date to the other devices of the ecosystems 100/200. For example, food may be delivered from feeder 12/212 after a certain amount of activity or, if the timestamp on the activity is specific to a time of day, simulation toy 218 may be activated in temporal proximity to extend activity time.

In one or more versions of the present disclosure, every device within systems 100/200, such as water dispenser 10/210, feeder 12/212, litterbox 214, exercise device 216, and stimulating toy 218 can communicate directly with one another, or, all communications from the devices within systems 100/200 can be routed to and through a communications hub, such as computational hub 20/220. In one or more versions, the communications may be in the form of human readable messages that contain information about what happened or what should happen. In one or more versions, the messages passed between devices may simply relay information (e.g., a timestamped temperature sensor reading) or may be a command (e.g., “turn on the feeder” or “turn on the wheel brake”). In one or more versions, the computations can be performed before or after the system sends a message. In one or more versions, all messages and computations are stored, and, in some versions, what was stored can become a message for a future device state. In one or more versions, the communication channel may include, among others, physical wire(s), Bluetooth®, WI-FI®, Ethernet cables, and the internet. In one or more versions, if present computational hub 20/220 may be any sufficiently powerful computing device or microcontroller, such as, but not limited to, a Raspberry Pi or Arduino.

In a direct connection version of systems 100/200, for example as shown in FIG. 1, one device may be directly connected to another. For example, as depicted in FIG. 1, water dispenser 10 may be directly connected to feeder 12. Water dispenser 10 has sensors on it (for example, a capacitance sensor that sits on top of a scale) and it sends communications directly to feeder 12. Feeder 12 in turn can drop small amounts of food into a receptacle. In one or more versions, an infrared beam detects when food has been delivered and a scale detects how much food was delivered and how much food may be remaining within feeder 12. In such a version, a signal can be sent directly from water dispenser 10 to feeder 12 after a certain amount of water has been delivered from water dispenser 10. The signal may say, in effect, “deliver food for 2 seconds” or “deliver 3 grams of food”, or something similar. Feeder 12 can receive the signal, deliver the food, and send back a signal saying, in effect, “food was delivered at <timestamp>” and another message saying, “and we detected the food in the food receptacle at <timestamp>.” By the phrase “direct connection” that present disclosure contemplates connection by wiring or connection through Bluetooth®, WI-FI®, Ethernet cables, and the internet.

Direct connections can also be set up between other devices. For example, with exercise device 16, sensors can measure the direction and rotation of the wheel. Similar with water dispenser 10/210, this information can be sent to feeder 12/212 to release food under certain conditions. In another example, an activity tracker can be fixed to an animal's collar, giving minute-by-minute readings of the animal's physical activity, which might cause feeder 12/212 to release food.

Some of the devices within systems 100/200 may need additional hardware to send signals to and from each other. For example, an Arduino may connect to a chip that reads a load balancing sensor located under water dispenser 10/210 to collect weights. The Arduino can be Bluetooth® or Wi-Fi® enabled to send and receive messages remotely, or it can be wired with a USB connector or Ethernet cable to send and receive messages directly, through a local area network, or the internet.

In a version of the system 200 that utilizes computational hub 220, such as shown in FIG. 2, the user may wish to link more than two devices together within system 200. In such versions, system 200 may use computational hub 220 to allow all the devices to communicate with each other. In these applications, the messages being sent are the same, but pass through computational hub 220. In one or more versions, computational hub 220 may be selected from a single Raspberry Pi, Arduino, or other computing device. This allows all the communication to be logged and stored in a single place within computational hub 220. It also allows system 200 to coordinate its messages, perform computations, and broadcast the results. For example, one might set up system 200 to have forced periods of inactivity after prolonged activity. In this case, computational hub 220 might collect readings of an activity tracker, water dispenser 210, feeder 212, litterbox 214, exercise device 216, and stimulating toy 218 in a single place. In one or more versions, computational hub 220 can then perform complex computations, machine learning, or other logic that boils down to something like “The animal has been very active for a long period of time and has not used the litterbox” and then it can send a message to all devices to stop delivering water and food, to put more resistance on the wheel, etc.

The foregoing description of versions and examples has been presented for purposes of illustration and description. It is not intended to be exhaustive or limiting to the forms described. Numerous modifications are possible in light of the above teachings. Some of those modifications have been discussed, and others will be understood by those skilled in the art. The versions were chosen and described in order to best illustrate principles of various versions as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. An animal welfare ecosystem comprising:
a plurality of animal interactive devices, wherein each animal interactive device of the plurality of animal interactive devices is capable of measuring an animal's interaction with said animal interactive device; and
a computational hub in a communicative connection with each animal interactive device of the plurality of animal interactive devices;
wherein animal interaction at one animal interactive device will activate one or more of the other animal interactive devices to perform an activity.

2. The animal welfare ecosystem of claim 1, wherein the measurement of animal interaction at any of the plurality of animal interactive devices is sendable to the computational hub, and wherein upon receipt of said measurement, the computational hub with analyze the measurement, and if the measurement reaches a pre-defined threshold of activity, the computational hub will communicate with a different animal interactive device than the one from which the measurement was received to have said different animal interactive device perform an activity.

3. The animal welfare ecosystem of claim 2, wherein the computational hub is a stand-alone device selected from a computing device or a microcontroller.

4. The animal welfare ecosystem of claim 2, wherein the computational hub is hardware selected from a computing device or a microcontroller located within one or more of the plurality of animal interactive devices.

5. The animal welfare ecosystem of claim 2, wherein the computational hub is software located within one or more of the plurality of animal interactive devices.

6. The animal welfare ecosystem of claim 1, wherein the communicative connection may be enabled through physical wire(s), Bluetooth®, WI-FI®, and/or Ethernet cables.

7. The animal welfare ecosystem of claim 1, wherein the computational hub is in communicative connection with a dashboard or mobile application, and wherein the computational hub is capable of sending the measurements of animal interaction with each animal interactive device of the plurality of animal interactive devices to the dashboard or mobile application.

8. The animal welfare ecosystem of claim 7, wherein the dashboard or mobile application can send activity instructions to the computational hub to be relayed to one or more animal interactive devices of the plurality of animal interaction devices.

9. The animal welfare ecosystem of claim 1, wherein the plurality of animal interaction devices is selected from a water dispenser, a feeder, a litterbox, an exercise device, and/or a stimulating toy.

10. The animal welfare ecosystem of claim 9, the water dispenser includes a water receptacle and a plate securely placed in a position in front of the water receptacle.

11. The animal welfare ecosystem of claim 10, wherein the water dispenser further includes a lick-circuit board which detects licks an animal takes from the water receptacle while sitting on the plate.

12. A method of monitoring health and behavior of one or more animals, the method comprising:
placing a plurality of animal interactive devices within a defined area, wherein each animal interactive device of the plurality of animal interactive devices is capable of measuring an animal's interaction with said animal interactive device,
placing a computational hub in communicative connection with each animal interactive device of the plurality of animal interactive devices within said defined area; and
placing one or more animals within said defined area;
wherein animal interaction at one animal interactive device will activate one or more of the other animal interactive devices to perform an activity.

13. The method of claim 12, wherein if more than one animal is placed within the defined area, each animal interactive device of the plurality of animal interactive devices will include an RFID reader, and each or the one or more animals will wear an RFID tag, such that each animal interactive device of the plurality of animal interactive devices will be able to identify which animal's interaction they are measuring.

14. The method of claim 13, wherein the computational hub is a stand-alone device selected from a computing device or a microcontroller.

15. The method of claim 13, wherein the computational hub is hardware selected from a computing device or a microcontroller located within one or more of the plurality of animal interactive devices.

16. The method of claim 13, wherein the computational hub is software located within one or more of the plurality of animal interactive devices.

17. The method of claim 13, wherein the communicative connection may be enabled through physical wire(s), Bluetooth®, WI-FI®, and/or Ethernet cables.

18. The method of claim 13, wherein the computational hub is in communicative connection with a dashboard or mobile application, and wherein the computational hub is capable of sending the measurements of animal interaction with each animal interactive device of the plurality of animal interactive devices to the dashboard or mobile application.

19. The method of claim 18, wherein the dashboard or mobile application can send activity instructions to the computational hub to be relayed to one or more animal interactive devices of the plurality of animal interaction devices.

20. The method of claim 19, wherein the plurality of animal interaction devices is selected from a water dispenser, a feeder, a litterbox, an exercise device, and/or a stimulating toy.
